(19) United States
(12) Patent Application Publication
(10) Pub. No.: US 2002/0090963 A1
(43) Pub. Date: Jul. 11, 2002

(54) Method for short message service forwarding delivery

(75) Inventors: Roberto Rocha Avalos, Saltillo (MX); Hector E. Monsivais De Valle, Saltillo (MX)

Correspondence Address: Mark V. Muller, Jenkens & Gilchrist, P.C., 3200 Fountain Place, 1445 Ross Avenue, Dallas, TX, 75202-2799, US

(73) Assignee: TELEFONAKTIEBOLAGET L M ERICSSON

(21) Appl. No.: 09/757,717

(22) Filed: Jan. 10, 2001

(51) Int. Cl. H04Q 7/20

(52) U.S. Cl. 455/466; 455/433; 455/435; 455/411

(57) ABSTRACT

A discrete message is forwarded from an initial destination to a forwarding destination within a network. Activation is requested of a forwarding feature. A discrete message is sent to the initial destination and a determination is made that the forwarding feature is activated. The initial destination is associated with a user profile, wherein the network includes a Switching Center (SC) and a Location Register (LR). When activation of a forwarding feature is requested, the forwarding feature is marked as activated in the user profile and the forwarding destination is stored. The user profile is downloaded from the LR to the SC, the forwarding destination is provided, and the discrete message is sent to the forwarding destination.

### BACKGROUND OF THE INVENTION

1. Technical Field

This invention relates generally to messaging systems and methods. More particularly, the invention relates to Short Message Service (SMS) delivery services conducted within a telecommunications network.

2. History of Related Art

The Short Message Service (SMS) provides the ability to send and receive short messages of up to 160 characters using a mobile phone. SMS was conceived as part of the Global System for Mobile communications (GSM) digital standard. SMS is typically used to communicate information when voice or audio is not the best medium. For example, when relating a phone number or other numerical information to another party, it is easier to send the number as a character message, where it can be extracted and stored in memory, rather than attempting to verbally relay the number, memorize it, and re-key it into a phone or other communications device for storage. Thus, SMS is a useful service for communicating non-audio information in many situations.

There are certain occasions when the intended recipient of SMS messages is unable to receive them. For example, when the intended destination telephone is busy, or unavailable (i.e., not responding due to being located outside the service zone, or being turned off). When these situations arise, the intended recipient must rely on a Message Center (MC) to deliver the messages at some later time. However, there is no guarantee that the MC will ultimately deliver the message to the intended recipient if his telephone is busy or unavailable. Further, there are times when the intended SMS recipient is waiting for a particular call, or otherwise occupied, and does not wish to receive any SMS messages. It is during these times that forwarding SMS messages to some guaranteed deliverable, alternative destination, would be desirable.

Thus, what is needed is a method of delivering SMS messages to the intended recipient even when the recipient's telephone is busy or unavailable. Further, such a method should provide the ability to deliver messages to an alternative destination. The method would be most useful if the message forwarding could be made contingent on instructions by the recipient, such as forwarding the message unconditionally, forwarding the message when the recipient telephone is busy, or forwarding the message when the recipient telephone does not respond. Finally, the method would also be most useful if the forwarding destination could also be selected, such as an alternate mobile telephone, a node, an e-mail address on a computer network, etc.

### SUMMARY OF THE INVENTION

The invention provides a method for forwarding discrete messages, such as SMS messages, from an initial destination (e.g., a cellular telephone) to a forwarding destination (e.g., an alternate cellular telephone, or a network address such as IP address or e-mail address). The method allows the intended recipient to specify the forwarding destination, and whether message forwarding will occur unconditionally, only when the recipient is busy, or only when the recipient telephone does not respond.

In its simplest form, the method includes the steps of activating a forwarding feature, sending a discrete message to the initial destination, and determining that the forwarding feature is activated. Of course, if it can not be determined that the forwarding feature has been activated, then the method terminates.

If the forwarding feature has indeed been activated, then the method may also include the steps of providing the forwarding destination, and sending the discrete message to the forwarding destination. These steps are used when the forwarding feature has been unconditionally activated.

If the forwarding feature is to be activated only when the initial destination is busy, then the forwarding destination will be provided, and the discrete message will be forwarded when the initial destination is busy. Similarly, if the forwarding feature has been requested for activation only when the initial destination is not responding, then the forwarding destination will be provided and the discrete message will be sent to the forwarding destination when the initial destination is not responding.

The forwarding destination may be an alternate telephone number, a network address, or any other destination which can be specified within a network data message. Activation of a forwarding feature can be requested by the intended recipient, the service provider, or triggered by REGISTRATIONNOTIFICATION/QUALIFICATIONREQUEST messages within American National Standards Institute—41 (ANSI-41) network protocol operations.

### BRIEF DESCRIPTION OF THE DRAWINGS

A more complete understanding of the structure and operation of the present invention may be had by reference to the following detailed description when taken in conjunction with the accompanying drawings, wherein:

FIGS. 1A, 1B and 1C are network operational diagrams illustrating activation of the forwarding feature;

FIG. 2 is a network operational diagram illustrating the method of the present invention wherein the forwarding feature is activated unconditionally;

FIG. 3 is a network operational diagram illustrating the method of the present invention when the forwarding destination is the Internet;

FIG. 4 is a network operational diagram illustrating the method of the present invention when the forwarding feature is activated when the initial destination is busy;

FIG. 5 is a network operational diagram illustrating the method of the present invention when the forwarding feature is activated when the initial destination is not responding; and

FIGS. 6A, 6B, and 6C are network operational diagrams illustrating the method of the present invention when message forwarding does not occur.

### DETAILED DESCRIPTION OF PRESENTLY PREFERRED EXEMPLARY EMBODIMENTS

The invention provides a method to forward discrete messages, upon request, from an intended recipient, or initial destination, to a selected forwarding destination. The intended recipient, typically operating a mobile cellular telephone, may select not only the forwarding destination, but may also select the conditions under which messages are forwarded: unconditionally, when his phone is busy, or when his phone is non-responsive (i.e., turned off, out of the service area, MS unknown, the MS has not subscribed to SMS, the addresses MS is unknown, or the SMS TeleserviceID is invalid).

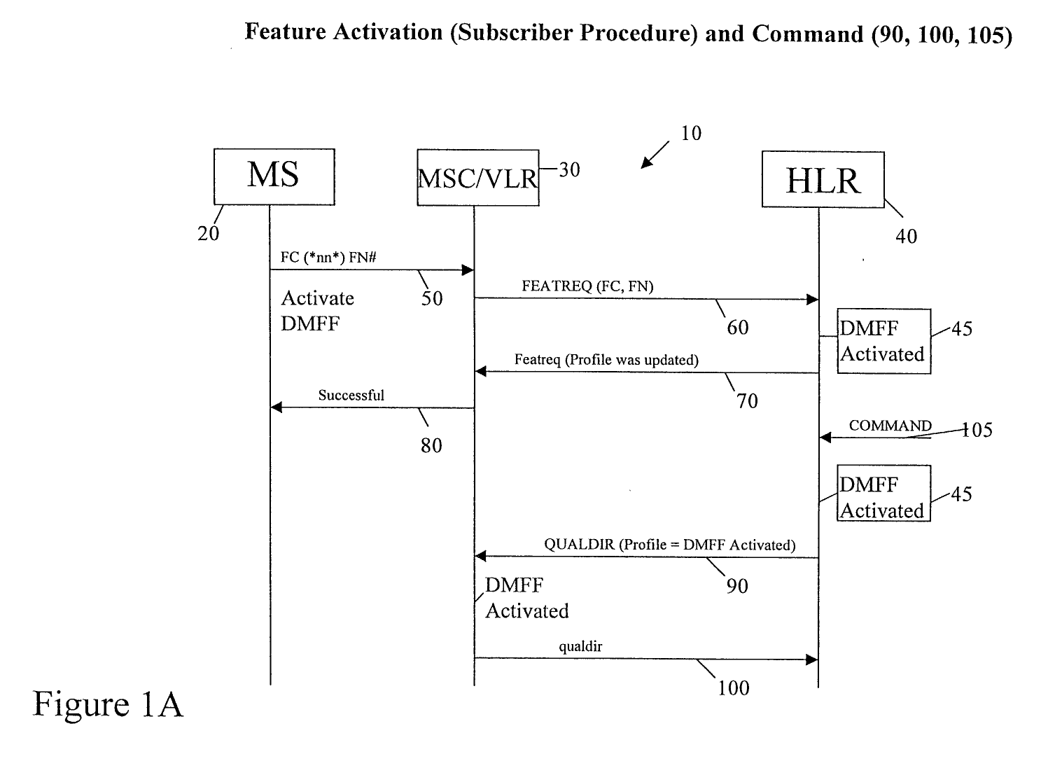

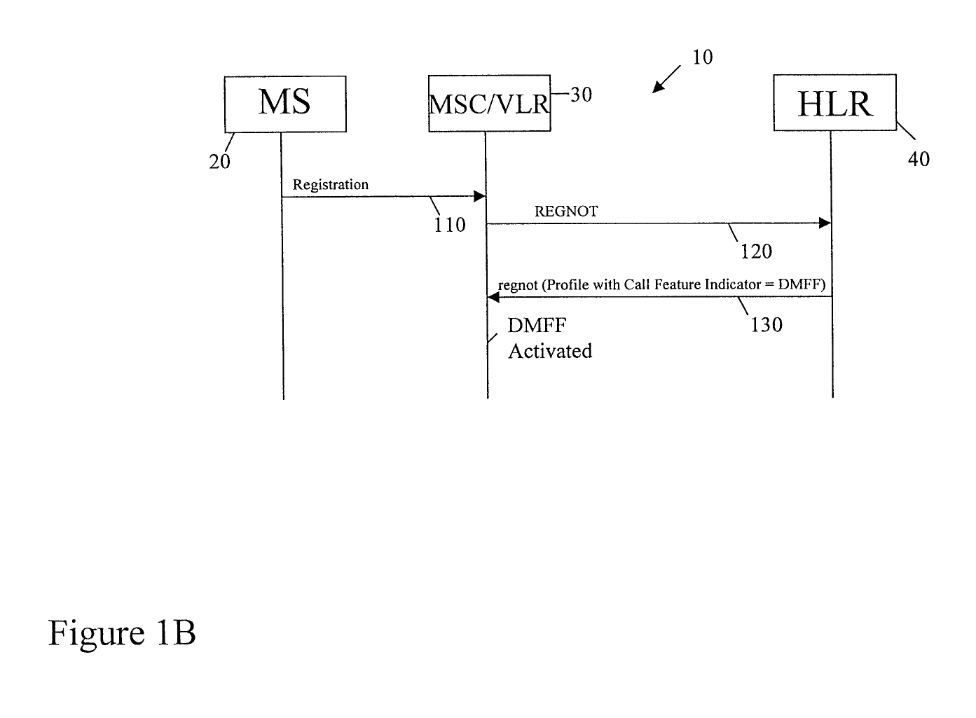

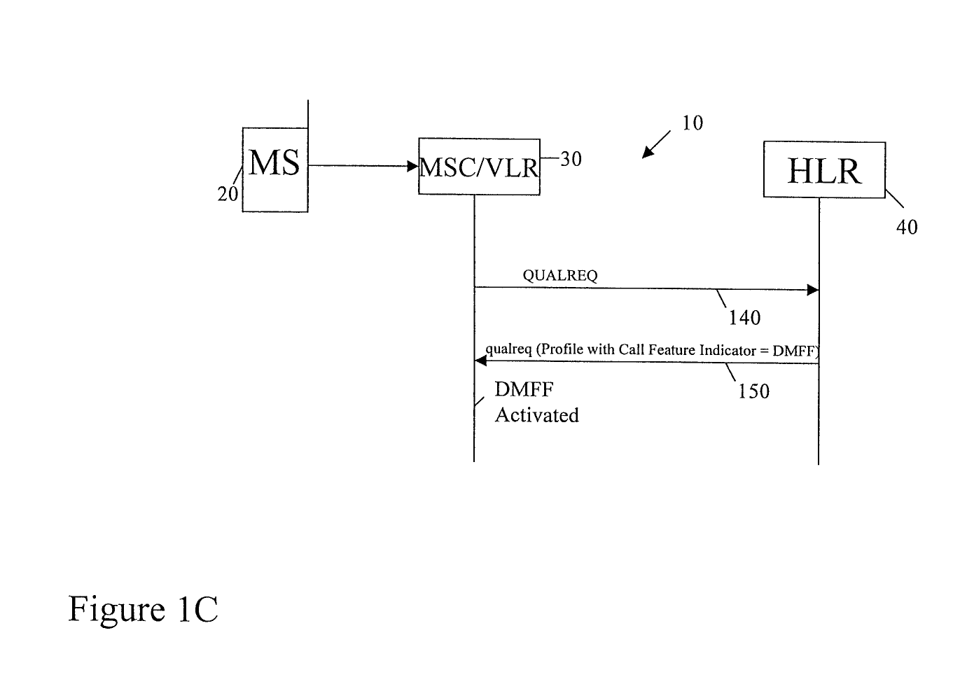

Turning now to FIGS. 1A, 1B, and 1C, a network diagram illustrating activation of the forwarding feature can be seen. In FIG. 1A, the network 10 includes a Mobile Station (MS) 20, a Mobile Switching Center/Visitor Location Register (MSC/VLR) 30, and a Home Location Register (HLR) 40. In this scenario, wherein the subscriber operating the MS 20 requests activation of the forwarding feature, an activation feature code, along with the forwarding destination, is entered by the subscriber, typically using the keypad of a cellular telephone, and sent to the MSC/VLR 30 in step 50. If the network 10 is an ANSI-41 compliant network, as shown in FIG. 1A, then a FEATUREREQUEST message is sent from the MSC/VLR 30 to the HLR 40, requesting that the user profile for the MS 20 be updated to indicate that the forwarding feature has been activated in step 60. After the profile has been updated, a featurerequest response message is sent from the HLR 40 to the MSC/VLR 30 in step 70, and typically, a confirmation message, indicating that the activation was successful, is sent from the MSC/VLR 30 to the MS 20 in step 80. The confirmation message may take the form of a message displayed on the MS 20 display, or an announcement to the subscriber. The confirmation message is typically followed by a QUALIFICATIONDIRECTIVE message from the HLR 40 to the MSC/VLR 30 in step 90, to update the profile information within the MSC/VLR 30 (to indicate that the forwarding feature is activated). To close the transaction, a qualificationdirective response message is returned from the MSC/VLR 30 to the HLR 40 in step 100. At this time, the HLR 40 will mark the forwarding feature as active in the user's profile, and store the forwarding destination address 45 (shown as FN# in FIG. 1A which can be a telephone number, an IP address or e-mail address).

If the forwarding destination is not SMS capable, or is not a valid destination, then the user profile may be updated, prompting unsuccessful forwarding of the message, until such time as the forwarding destination becomes SMS capable. Alternatively, the user profile may not be updated, and notification of the unsuccessful profile update will be sent to the user (not shown).

Turning now to FIG. 1B, a network operational diagram illustrating activation of the forwarding feature upon registration can be seen. In this case, when the MS 20 attempts to register with the MSC/VLR 30, by way of autonomous registration in step 110, for example, the MSC/VLR 30 sends a REGISTRATIONNOTIFICATION message from the MSC/VLR 30 to the HLR 40 in step 120, and the HLR 40 responds with a registrationnotification response, including the user profile, and an indication that the forwarding feature is activated in step 130. At this time, the MSC/VLR 30 is now “aware” that the forwarding feature has been activated for the MS 20. A similar operation occurs when an MSC/VLR in a network requests validation of an MS, such that a QUALIFICATIONREQUEST message is sent from the MSC/VLR 30 to the HLR 40 in step 140, and the qualificationrequest response includes the profile, with an indication that the forwarding feature is active, in step 150 (see FIG. 1C). It should be noted that in all the operations illustrated in FIGS. 1A, 1B, and 1C, the type of activation for the forwarding feature depends on either the feature code (for a subscriber activation request), the command from an operator, or the type of activation indicated in the user profile. Thus, for example, a subscriber may request unconditional activation, activation when busy, or activation when not responding, using different feature code combinations.

The forwarding feature may also be activated by command of the service provider operator, as shown in FIG. 1A. Here, a command can be issued by the operator in step 105 to the HLR 40, which directs the HLR 40 to send a QUALIFICATIONDIRECTIVE message, including profile information indicating that the forwarding feature has been activated in the user profile in step 90, which provokes a qualificationdirective response, confirming update of the user profile in the MSC/VLR 30, in step 100. If the requested forwarding destination is not SMS capable, or a valid destination, the user profile will not be updated, and notification of the unsuccessful profile update will be sent to the user (not shown).

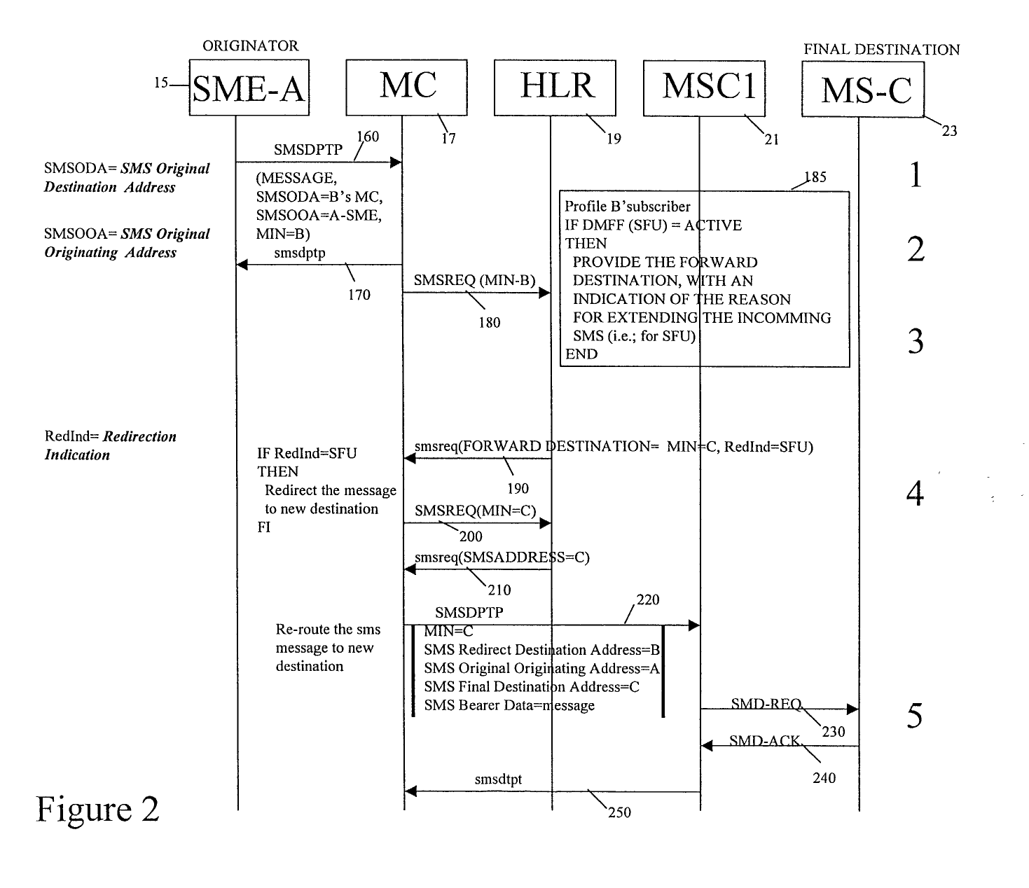

A network operational diagram, illustrating the method of the present invention wherein a discrete message, in the form of an SMS message, is forwarded unconditionally to a mobile station, is shown in FIG. 2. Here, the originator of the message, Short Message Entity (SME) 15 sends a short message to Mobile Identification Number B (MINB), which is served by the Message Center (MC) 17 and the HLR 19. In this case, MINB represents the initial destination.

The message is sent using an SMS Delivery Point-To-Point (SMSDPTP) Invoke operation, which includes the short message itself, the SMS original, or initial destination address (which is the MC for MINB), the SMS original originating address, which is the address for the SME 15, and the initial destination, or MINB. The SMSDPTP Invoke message is sent from the SME 15 to the MC 17 in step 160. A smsdptp response is returned from the MC 17 to the SME 15 to acknowledge receipt of the original SMSDPTP message. In step 180, the MC 17 sends a request to the HLR 19 to provide the address of the MINB in step 180. This request from the MC 17 to the HLR 19 takes the form of an SMSREQUEST, which contains the MINB. The HLR checks to determine that the forwarding feature is activated by referring to the subscriber profile associated with the MINB in step 185. In the response (step 190), the MC 17 receives the information that the forwarding feature is unconditionally activated (i.e., the redirection indication equals SFU), and that the forwarding destination is the Mobile Identification Number (MIN) associated with a user “C”, or MINC.

In this scenario, the method includes the steps of providing the forwarding destination, and sending the discrete message, in the form of an SMS message, to the forwarding destination. Thus, the SMSREQUEST, containing the MINC is sent back to the HLR 19 (in step 200), assuming that the HLR 19 serves both user “B” and user “C”. The response, received in step 210, includes the SMSADDRESS, which points to MSC/VLR1 21.

The message is now rerouted, using the SMSDPTP operation, to mobile station “C” in step 220. At this time, the MIN is that of the entity serving MS “C” (i.e., MS-C) 23, the SMS redirect destination address is that for MS “B” (not shown), and the SMS original originating address is that for entity “A” (e.g. MS “A”, not shown), served by SME-A 15. The final destination address is that for MS-C 23 and the SMS Bearer Data is the message itself. The short message is delivered to the MS-C 23 in step 230, and receipt of the message is acknowledged in step 240 by the MS-C 23 to the MSC/VLR1 21. The transaction is closed with an smsdptp response in step 250, from the MSC/VLR1 21 to the MC 17.

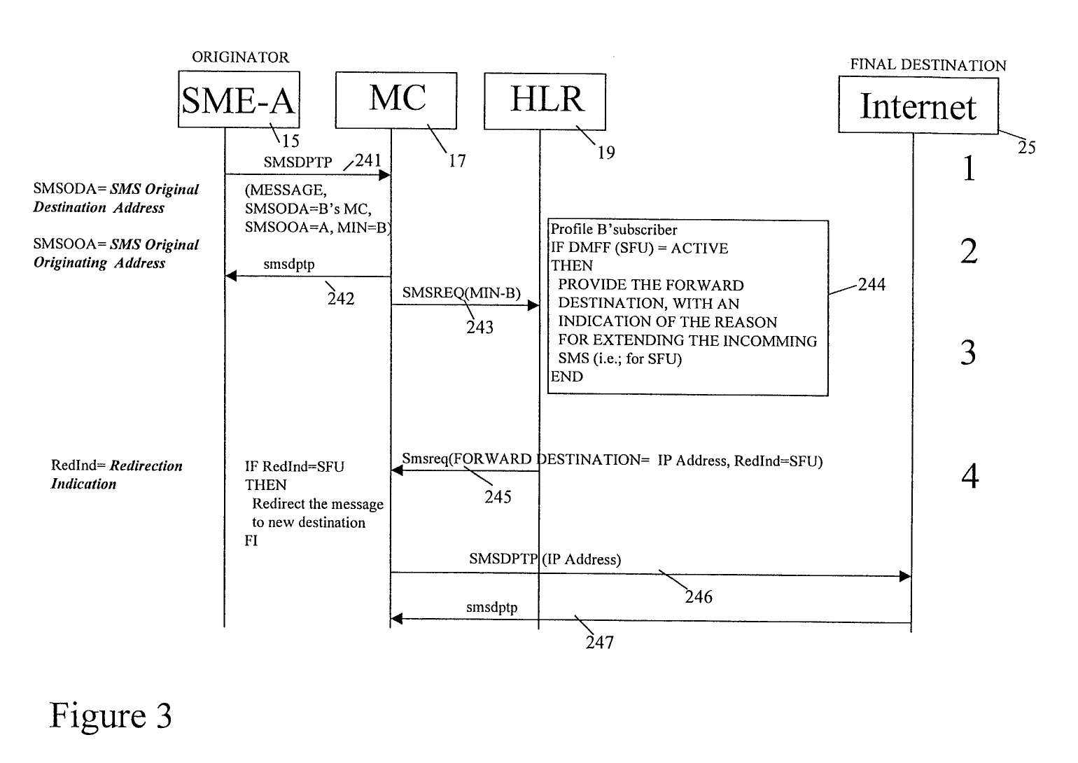

FIG. 3 illustrates a network operational diagram wherein the short message is forwarded unconditionally to the Internet. In this case, the message originator 15, which might be a node or MSC/VLR for entity “A” (e.g., a mobile cellular telephone), sends an SMSDPTP message to the MC 17 in step 241. An smsdptp response is returned from the MC 17 to the message originator 15 in step 242. Again, an SMSREQUEST, including the MINB is sent from the MC 17 to the HLR 19 for entity “B”, which may be another mobile cellular telephone. This request for the address of MINB occurs in step 243. The HLR 19 checks to determine whether the forwarding feature has been activated in step 244. Upon determining that the forwarding feature has been activated unconditionally, the forwarding destination, which in this case is an Internet address, is returned in the smsrequest response in step 245. It is important to note that in this instance, as well as in that illustrated in FIG. 2, the forwarding feature has been activated unconditionally, and therefore, whether the intended recipient (i.e., entity “B”) is busy or not responding does not matter. All discrete messages will be forwarded, regardless of the status of the intended recipient. Thus, a new SMSDPTP message is sent from the MC 17 to the Internet, containing the forwarding destination address in the form of an Internet Address or E-mail Address 25, in step 246. The smsdptp response, used to the close the transaction, is returned from the Internet 25 to the MC 17 in step 247.

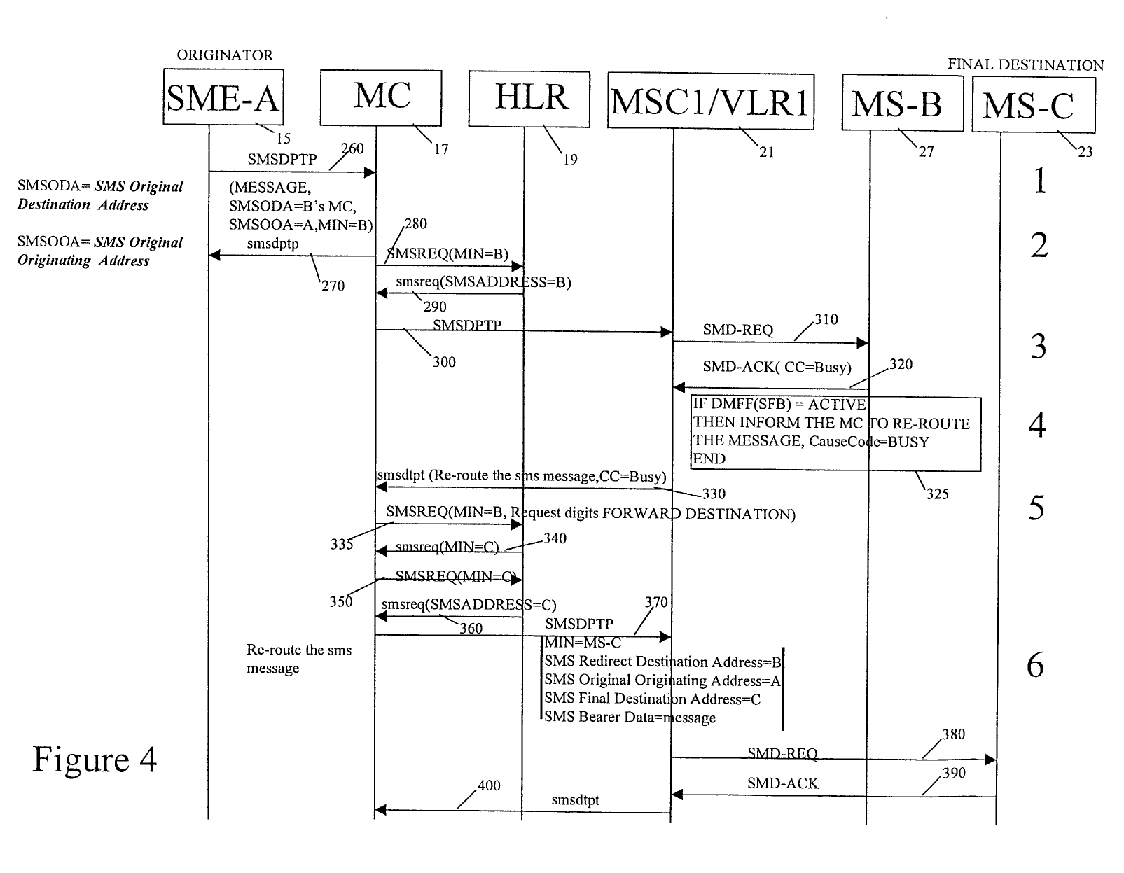

Turning now to FIG. 4, a network operational diagram illustrating the method of the present invention wherein the forwarding feature is activated when the initial destination is busy. Thus, the initial destination (i.e., MINB, or entity “B”) toward which the discrete message is directed has previously requested activation of the forwarding feature when the initial destination is busy, and provided a forwarding destination to the HLR 19.

When the message originator 15, such as a MSC/VLR serving entity “A” sends an SMSDPTP message in step 260, the message is acknowledged by an smsdptp response in step 270. The SMSDPTP message contains the SMS message itself, the initial destination address (i.e., the MC 17 for MINB), and the SMS originating entity address (i.e., the address for entity “A”), along with MINB itself.

The MC 17 then responds by sending an SMSREQUEST message containing the MINB in step 280 to the HLR 19. The smsrequest response, containing the SMSADDRESS for MINB is returned by the HLR 19 to the MC 17 in step 290.

After receiving the SMSADDRESS, the MC 17 requests delivery of the SMS message by MSC/VLR1 21 (which serves the initial destination, MS-B 27) using an SMSDPTP message in step 300. Delivery is attempted in step 310, and fails because the request is acknowledged with an indication that the MS-B 27 is busy in step 320. The MSC/VLR1 21 then checks to determine that the forwarding feature has been activated in step 325, and since the forwarding feature is indeed activated when the initial destination is busy, the MSC/VLR 21 sends the forwarding information, directing the MC 17 to reroute the SMS message using an smsdptp response in step 330. An SMSREQUEST message in step 335 is used to request the forwarding destination from the HLR 19, and the SMSREQUEST response, including MINC, is returned to the MC 17 in step 340.

The MC 17 then sends a new SMSREQUEST containing the MIN C to the HLR 19, requesting the SMSADDRESS for MS-C 23 in step 350, in this case the SMSADDRESS for entity “C”, or MS-C 23 is returned in the smsrequest response in step 360.

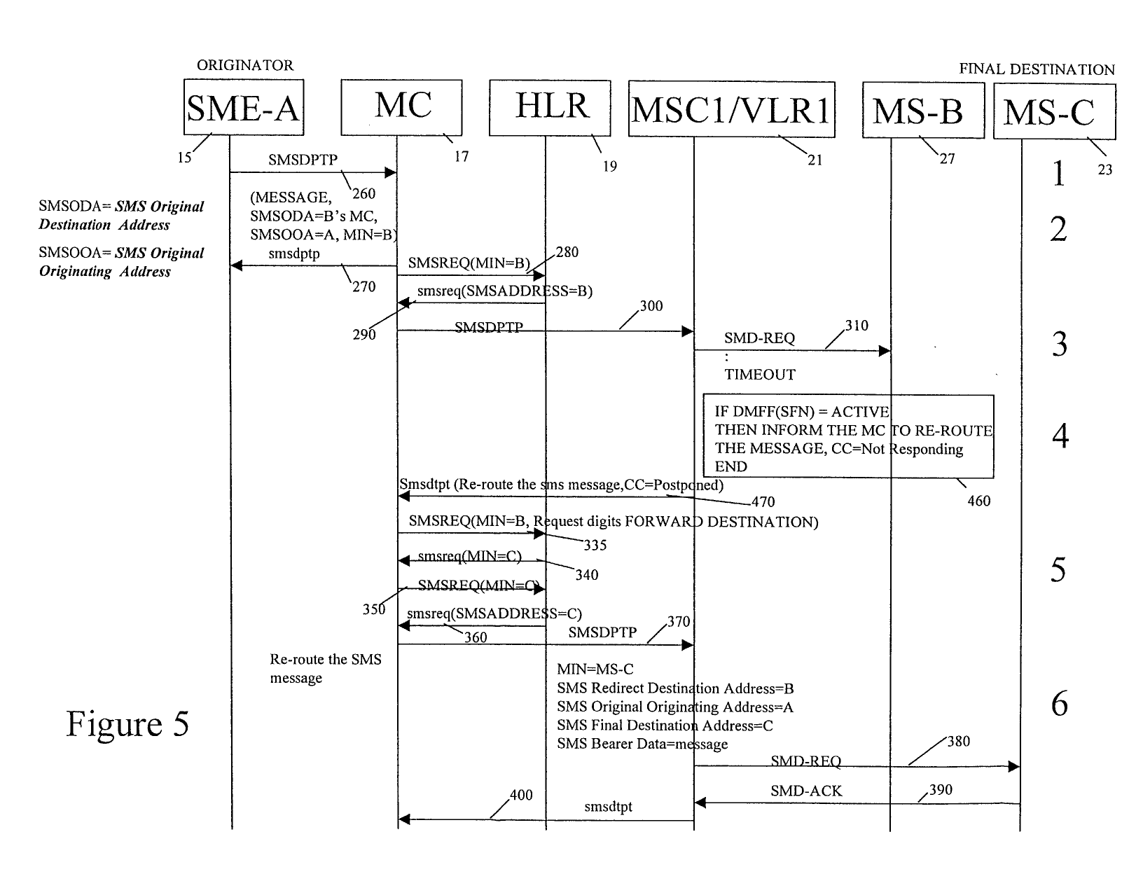

Once the MC 17 receives the forwarding address for MS-C 23, the MC 17 requests that the discrete message be forwarded to MS-C 23 using an SMSDPTP message in step 370. The message is delivered in step 380, and delivery/receipt is acknowledged in step 390. The transaction is closed using an smsdptp response in step 400. A similar process is illustrated in FIG. 5, which shows a network operational diagram of the method wherein the forwarding feature has been activated when the initial destination is not responding. In this case, the forwarding feature has been activated for MS-B 27 such that messages are forwarded to the alternative destination, MS-C 23, when the status of the MS-B 27 is “not responding” (i.e., turned off, out of the service area, MS unknown, the MS has not subscribed to SMS, the addresses MS is unknown, the SMS TeleserviceID is invalid).

In this case, steps 260-310 are identical to those described for FIG. 4. That is, a short message is originated and sent to the MC 17, the SMSADDRESS for MS-B 27 is requested and received by the MC 17, and a request to deliver the message, and an attempt to deliver the message, are made in steps 300 and 310. However, in this case, instead of the MS-B 27 being busy, it is not responding, and therefore, no acknowledgment is received by the MSC/VLR1 21 from the MS-B 27. After an acknowledgment time-out occurs, the MSC/VLR1 21 checks to determine if the forwarding feature has been activated, and if so, whether the forwarding feature has been activated when the initial destination is not responding in step 460. In this case, the forwarding feature has indeed been activated, and is activated when the initial destination is not responding.

Thus, the smsdptp response is sent from the MSC/VLR1 21 to the MC 17, directing the MC 17 to reroute the SMS message in step 470. Steps 335-400 are the same as those described for FIG. 4. That is, a new request for the identity and address of the forwarding destination is made by the MC 17, and after the SMSADDRESS for MS-C 23 is received by the MC 17, a request for delivery of the message is made to the MSC/VLR 21. The message is then delivered, acknowledged, and the transaction is closed in steps 380-400.

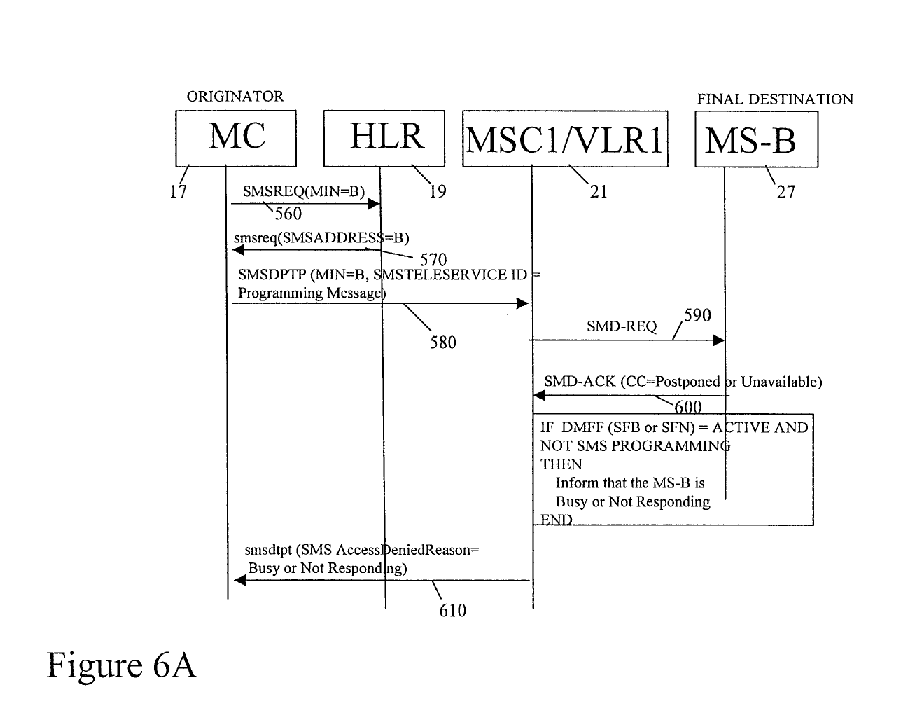

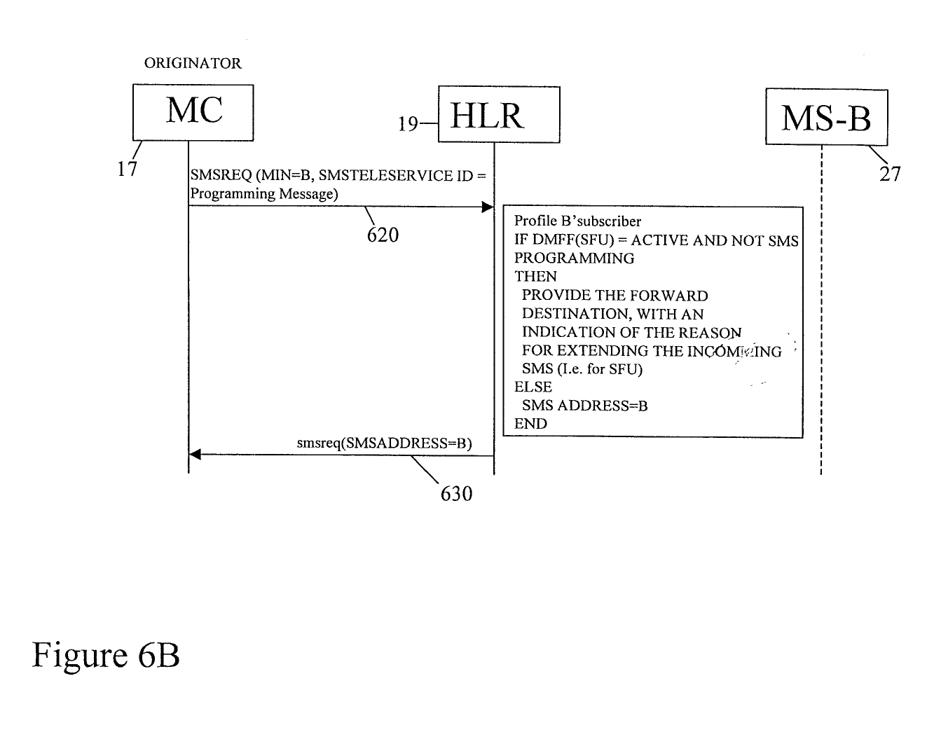

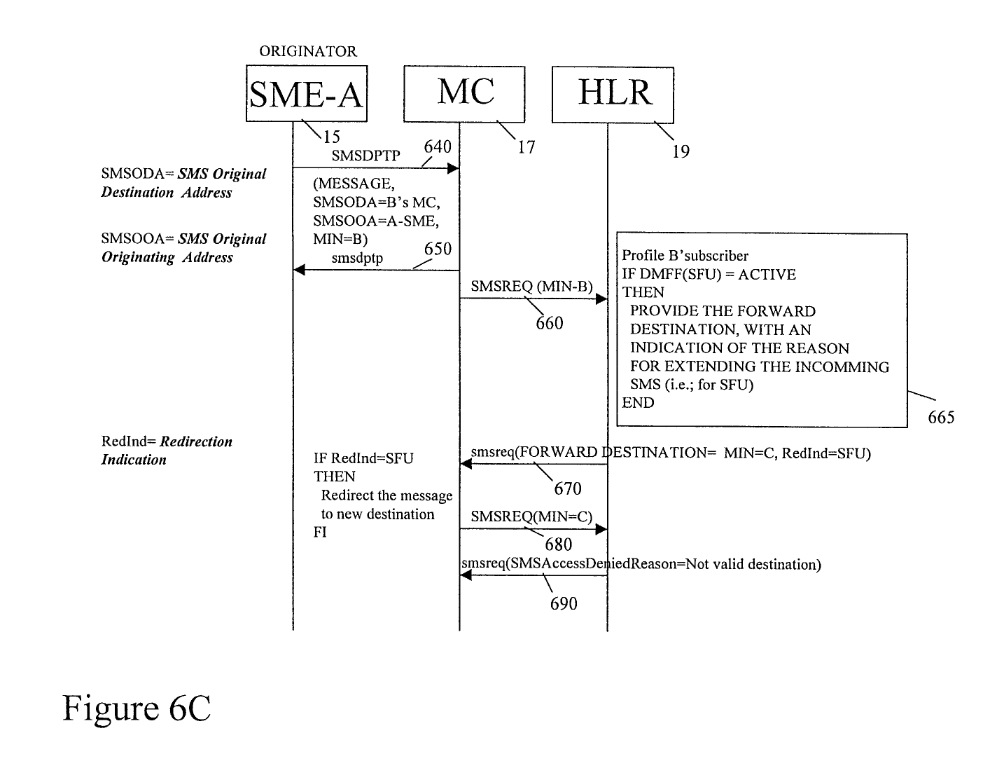

FIGS. 6A, 6B, and 6C are network operational diagrams illustrating the method of the invention as it operates when the discrete message should not be forwarded (e.g., the SMS message is a programming message specific to the intended recipient), or it is impossible to deliver the discrete message (e.g., the forwarding destination is invalid). FIGS. 6A and 6B illustrate the circumstances wherein the discrete message is a programming message specific to MS-B 27. In FIG. 6A, the MC 17 sends an SMSREQUEST message directed toward MS-B 27 in step 560, in order to determine the forwarding destination address of MS-B 27. The smsrequest response containing the SMSADDRESS for MS-B 27 is returned by the HLR 19 to the MC 17 in step 570. Then, the MC 17 requests the MSC/VLR 121 to deliver the message to MS-B 27 using an SMSPTP message in step 580 containing the SMS Teleservice Indicator parameter, which indicates that the SMS message is a programming message specific to the intended recipient. Delivery is attempted in step 590, however, the MS-B 27 is not responding, or busy. Thus, the delivery attempt is acknowledged in step 600 to the MSC/VLR1 21 by the MS-B 27.

At this point, the MSC/VLR 21 checks to determine if the forwarding feature is activated when the initial destination is not responding or busy. Since this is indeed the case, and delivery of the SMS message (which is a programming message) is not appropriate, the smsdptp response indicates the condition of the MS-B 27 as not responding or busy in step 610, and the programming message is not forwarded. Thus, in this case, the delivery of the programming message occurs by way of conventional methods, well known to those skilled in the art.

The scenario depicted in FIG. 6B is similar to that shown in FIG. 6A, except that the forwarding feature is activated unconditionally. In this case, the MC 17 requests the address for MS-B 27 from the HLR 19 by sending a SMSREQ message 620 containing the SMS Teleservice Indicator parameter, which indicates that the SMS message is a programming message specific to the intended recipient. Since the DMFF is activated unconditionally and the SMS is a programming message; then it would not be appropriate to forward a programming message intended for the MS-B 27, the smsrequest response returned in step 630 contains the SMSADDRESS for MS-B 27. Thus, the message, which is a programming message intended for the initial destination, is not forwarded. Message delivery is again accomplished using conventional methods well known to those skilled in the art.

Turning now to FIG. 6C, the method of the invention is illustrated when forwarding is not possible because the forwarding destination is invalid, or not SMS capable. In this instance, the originating entity sends the SMS message by way of the MC 17 in step 640, to MS-B 27. After acknowledging receipt of the message with the smsdptp response in step 650, the MC 17 sends a request to the HLR 19 for the address of MS-B 27 in step 660. Since the forwarding feature is activated (in this case, unconditionally, as determined in step 665), then the forwarding destination is returned by the HLR 19, along with an indication of the activation type, in the smsrequest response of step 670. The MC 17 then submits an SMSREQUEST message, requesting the address of the forwarding destination (MS-C 23, which is not SMS-capable in this scenario) in step 680. Since MS-C 23 is not SMS-capable, the smsrequest response returned in steps 690, normally containing the SMSAccessDeniedReason, informs the MC 17 that the forwarding destination is invalid.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. A method for forwarding a discrete data message from an initial destination to a forwarding destination within a network, comprising the steps of:
sending the discrete message to the initial destination; and
determining that a user at the initial destination desires for the message to be forwarded to a user specified forwarding destination.

2. The method of claim 1, further including the step of:
requesting activation of a forwarding feature.

3. The method of claim 1, further including the step of:
forwarding the discrete message on to the specified forwarding destination.

4. The method of claim 1, further including the step of:
validating the discrete message as a valid message for the forwarding destination.

5. The method of claim 1, wherein the initial destination is associated with a user profile, wherein the network includes a Switching Center (SC) and a Location Register (LR), and further including the step of requesting activation of the forwarding feature further comprises the steps of:
sending an activation feature code and the forwarding destination from the initial destination to the SC;
sending a message requesting activation of the forwarding feature and the forwarding destination from the SC to the LR; and
updating the user profile in the LR to indicate the forwarding feature is activated.

6. The method of claim 5, further including the step of:
validating the forwarding destination as a valid destination for delivering a discrete message.

7. The method of claim 5, further including the step of sending a confirmation message from the SC to the initial destination, wherein the confirmation message indicates the forwarding feature is activated.

8. The method of claim 1, wherein the initial destination is associated with a user profile, wherein the network includes a Switching Center (SC) and a Location Register (LR), and wherein the step of requesting activation of a forwarding feature further comprising the steps of:
marking the forwarding feature as activated in the user profile; and
storing the forwarding destination.

9. The method of claim 8, further including the step of:
validating the forwarding destination as a valid destination for delivering a discrete message.

10. The method of claim 8, further including the step of:
downloading the user profile from the LR to the SC.

11. The method of claim 1, wherein the discrete message is a Short Message Service (SMS) message.

12. The method of claim 1, wherein the forwarding destination is a telephone number.

13. The method of claim 1, wherein the forwarding destination is a network address.

14. The method of claim 1, wherein the network includes a Message Center (MC), and wherein the step of sending the discrete message to the initial destination further comprises the step of sending a SMS Delivery Point-To-Point Invoke message including the initial destination to the MC.

15. The method of claim 1, further comprising the steps of:
providing the forwarding destination; and
sending the discrete message to the forwarding destination.

16. The method of claim 1, wherein the step of determining that the forwarding feature is activated further includes the step of:
determining that the forwarding feature is unconditionally activated.

17. The method of claim 16, further comprising the steps of:
providing the forwarding destination; and
sending the discrete message to the forwarding destination.

18. The method of claim 1, wherein the step of determining that the forwarding feature is activated further includes the step of:
determining that the forwarding feature is activated when the initial destination is busy.

19. The method of claim 18, further comprising the steps of:
providing the forwarding destination; and
sending the discrete message to the forwarding destination.

20. The method of claim 1,wherein the step of determining that the forwarding feature is activated further includes the step of.
determining that the forwarding feature is activated when the initial destination is not responding.

21. The method of claim 20, further comprising the steps of:
providing the forwarding destination; and
sending the discrete message to the forwarding destination.

22. A method for forwarding a discrete data message from an initial destination to a forwarding destination within a network, comprising the steps of:
sending the discrete message to the initial destination wherein the discrete message is a Short Message Service (SMS) message; and
determining that a user at the initial destination desires for the message to be forwarded to a user specified forwarding destination.

23. The method of claim 22, further comprising the step of:
requesting activation of a forwarding feature.

24. The method of claim 22, further comprising the step of:
forwarding the discrete message on to the specified forwarding destination.

25. The method of claim 22, further comprising the step of:
validating the discrete message as a valid message for the forwarding destination.

26. The method of claim 22, further comprising the steps of:
providing the forwarding destination;
sending the discrete message to the forwarding destination, wherein the initial destination is associated with a user profile, wherein the network includes a Switching Center [SC] and a Location Register (LR), and wherein the step of requesting activation of a forwarding feature further comprises the steps of:
sending an activation feature code and the forwarding destination from the initial destination to the SC;
sending a message requesting activation of the forwarding feature and the forwarding destination from the SC to the LR; and
updating the user profile in the LR to indicate the forwarding feature is activated.

27. The method of claim 26, further including the step of:
validating the forwarding destination as a valid destination for delivering a discrete message.

28. The method of claim 22, further comprising the steps of:
providing the forwarding destination;
sending the discrete message to the forwarding destination, wherein the initial destination is associated with a user profile, wherein the network includes a Switching Center (SC) and a Location Register (LR), and wherein the step of requesting activation of a forwarding feature further comprising the steps of:
marking the forwarding feature as activated in the user profile; and
storing the forwarding destination.

29. The method of claim 28, further including the step of:
validating the forwarding destination as a valid destination for delivering a discrete message.

30. A method for forwarding a discrete data message from an initial destination to a forwarding destination within a network, comprising the steps of:
requesting activation of a forwarding feature;
sending the discrete message to the initial destination;
determining that a user at the initial destination desires for the message to be forwarded to a user specified forwarding destination, wherein the initial destination is associated with a user profile, wherein the network includes a Switching Center (SC) and a Location Register (LR), and wherein the step of requesting activation of a forwarding feature further comprising the steps of:
marking the forwarding feature as activated in the user profile;
storing the forwarding destination;
downloading the user profile from the LR to the SC;
providing the forwarding destination; and
forwarding the discrete message on to the specified forwarding destination.

31. The method of claim 30, further including the step of:
validating the forwarding destination as a valid destination for delivering a discrete message.
